(19) United States
(12) Patent Application Publication
(10) Pub. No.: US 2026/0105566 A1
(43) Pub. Date: Apr. 16, 2026

(54) METHOD FOR IMAGE EXTENSION, COMPUTER READABLE STORAGE MEDIUM, AND ELECTRONIC DEVICE

(71) Applicant: Beijing Zitiao Network Technology Co., Ltd., Beijing (CN)

(72) Inventor: Qianqian WANG, Beijing (CN)

(21) Appl. No.: 19/116,989

(22) PCT Filed: Sep. 18, 2023
(86) PCT No.: PCT/CN2023/119397

§ 371 Date: Mar. 28, 2025

(30) Foreign Application Priority Data
Sep. 29, 2022 (CN) 202211197748.6

(51) Int. Cl. G06T 3/4038; G06T 3/60; G06T 7/11

(52) U.S. Cl. CPC G06T 3/4038; G06T 3/60; G06T 7/11; G06T 2207/20021; G06T 2207/20221

(57) ABSTRACT

The present disclosure provides a method for image extension, a storage medium and an electronic device. And the method includes: obtaining a first image, and determining a first region on one side of the first image; flipping the first image in a direction toward the first region to obtain a second image; splicing the first image, the first region, and the second image to obtain a third image, where the first region is between the first image and the second image; and performing extension based on the third image to obtain a target image.

The present application claims the priority and benefits of Chinese Patent Application No. 202211197748.6, filed on Sep. 29, 2022, which is incorporated herein by reference in its entirety as part of the present application.

### TECHNICAL FIELD

The embodiment of the disclosure relates to a method for image extension, an apparatus, a storage medium and an electronic device.

### BACKGROUND

With the ceaseless development and improvement of image processing technologies, images have become increasingly extensive in their application. In some application scenes, original images have a size that cannot meet the requirements for their application and accordingly must be processed to a specified size before their use, e.g., cropping or performing extension original images, etc. It is more difficult to extend original images. Therefore, there is a need for a solution for image extension.

### SUMMARY

The present disclosure provides a method for image extension, an apparatus, a storage medium and an electronic device.

According to a first aspect, embodiments of the present disclosure provide a method for image extension, and the method includes:

obtaining a first image, and determining a first region on one side of the first image;

flipping the first image in a direction toward the first region to obtain a second image;

splicing the first image, the first region, and the second image to obtain a third image, wherein the first region is between the first image and the second image; and

performing extension based on the third image to obtain a target image.

According to a second aspect, embodiments of the present disclosure provide an apparatus for image extension, and the apparatus includes:

a determining module is configured to obtain a first image, and determine a first region on one side of the first image;

a flipping module is configured to flip the first image in a direction toward the first region to obtain a second image;

a splicing module is configured to splice the first image, the first region, and the second image to obtain a third image, wherein the first region is between the first image and the second image; and

an extending module is configured to perform extension based on the third image to obtain a target image.

According to a third aspect, embodiments of the present disclosure provide a computer-readable storage medium, the storage medium storing a computer program, the computer program being executed by a processor to implement the method described in any one of the first aspect.

According to a fourth aspect, embodiments of the present disclosure provide an electronic device, and the electronic device includes a memory, a processor and a computer program stored on the memory and runnable on the processor, the processor realizing the method described in any one of the first aspects when the program is executed by the processor.

### BRIEF DESCRIPTION OF DRAWINGS

To illustrate the technical solution of the embodiments of the present disclosure more clearly, the drawings that need to be used in the description of the embodiments are briefly introduced below. It is obvious that the drawings in the following description are merely some embodiments of the present disclosure, and for those ordinary skilled in the art, other drawings can also be attained from these drawings without any creative effort.

FIG. 1A is a schematic scene diagram of an extended image according to an exemplary embodiment of the present disclosure;

FIG. 1B is a schematic scene diagram of another extended image according to an exemplary embodiment of the present disclosure;

FIG. 1C is a schematic scene diagram of another extended image according to an exemplary embodiment of the present disclosure;

FIG. 1D is a schematic scene diagram of another extended image according to an exemplary embodiment of the present disclosure;

FIG. 2 is a flowchart illustrating a method for image extension according to an exemplary embodiment of the present disclosure;

FIG. 3 is a flowchart illustrating another method for image extension according to an exemplary embodiment of the present disclosure;

FIG. 4 is a block diagram of an apparatus for image extension according to an exemplary embodiment of the present disclosure;

FIG. 5 is a schematic block diagram of an electronic device according to some embodiments of the present disclosure;

FIG. 6 is a schematic block diagram of another electronic device according to some embodiments of the present disclosure; and

FIG. 7 is a schematic diagram of a storage medium according to some embodiments of the present disclosure.

### DETAILED DESCRIPTION

To enable those skilled in the art to better understand the technical solution in the present specification, the technical solution in the embodiments of the present disclosure will be clearly and thoroughly described below in conjunction with the drawings in the embodiments of the present disclosure. Obviously, the described embodiments are only some embodiments of the present disclosure, not all of them. Based on the embodiments of the present disclosure, all other embodiments attained by those ordinary skilled in the art without creative efforts shall fall within the scope of protection of the present disclosure.

When the drawings are involved in the following description, the same number in different drawings represents the same or similar elements, unless otherwise indicated. The implementations described in the following exemplary embodiments do not represent all implementations consistent with the present disclosure. On the contrary, they are only examples of the apparatus and method that are consistent with some aspects of this disclosure, as detailed in the attached claims.

The terms used in the present disclosure are intended solely to illustrate specific embodiments and are not intended to limit the present disclosure. The singular forms “a”, “said” and “the” as used in the present disclosure are also intended to include plural forms, unless the context clearly indicates otherwise. It should also be appreciated that the term “and/or” as used herein refers to and encompasses any or all possible combinations of one or more associated listed items.

It should be understood that although the terms first, second, third, etc. may be used in the present disclosure to describe various types of information, such information should not be limited to these terms. These terms are only used to distinguish information of the same type from each other. For example, the first information may also be referred to as the second information without departing from the scope of the present disclosure, and similarly, the second information may also be referred to as the first information. Depending on the context, the word “if” as used here can be interpreted as “while . . . ” , or “when . . . ” , or “in response to determining . . . ”.

With the ceaseless development and improvement of image processing technologies, images have become increasingly extensive in their application. In some application scenes, original images have a size that cannot meet the requirements for their application and accordingly, must be processed to a specified size before their use, e.g., cropping or performing extension an original image, etc. It is more difficult to extend an original image. In general, the image in an extension region is predicted directly from the original image, thus realizing padding for the extension region. However, when the extension region is relatively large, the predicted image in the extension region will be severely distorted, resulting in an unsatisfactory display effect.

According to a method for image extension provided in the present disclosure, a to-be-extended first image is flipped to obtain a second image, a to-be-padded first region located on one side around the first image is between the first image and the second image for splicing, so as to obtain a third image, and the third image is extended to obtain a target image. The to-be-padded first region is between the to-be-extended first image and the second image obtained by flipping the first image, the first region is padded by reference to a pixel of the first image and a pixel of the second image, so during padding for the first region, each pixel in the first region is not too far away from its reference pixel, such that the image of the first region obtained by extension is more realistic, and the display effect is better and more coherent.

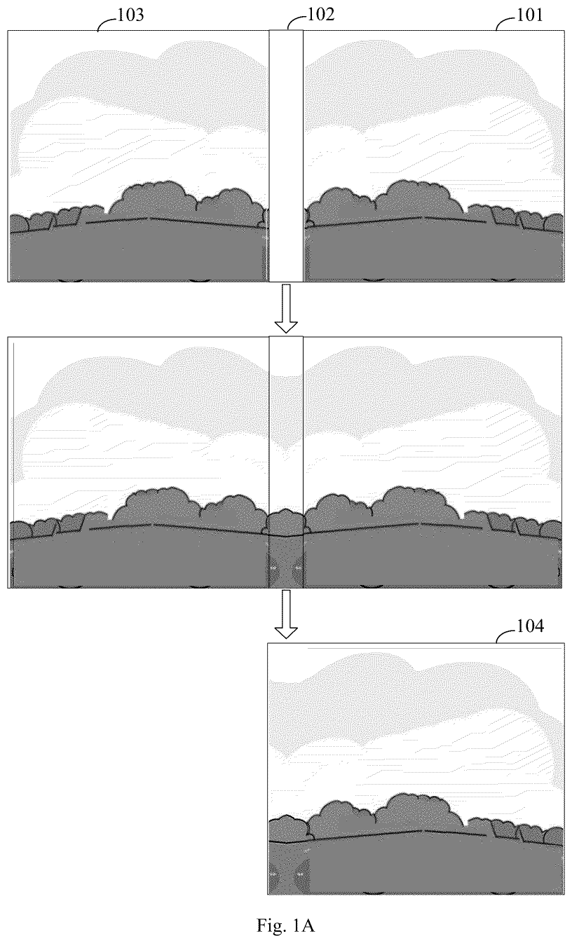

Reference is made to FIG. 1A to FIG. 1D, which are schematic scene diagrams of extended images according to an exemplary embodiment. The specific application scene may be that an original image 101 has a quite small width and needs to be extended to increase its width.

As shown in FIG. 1A, in an implementation, at first, extension is determined to be performed on the left side of the image 101, a region 102 located on the left side of the image 101 is taken as a to-be-padded region, and the image 101 is horizontally mirror-flipped to obtain an image 103. The image 101, the region 102, and the image 103 are spliced so that the region 102 is located between the image 101 and the image 103, after which the region 102 is padded according to the image 101 and the image 103, and the image 103 is deleted to obtain an extended target image 104.

As shown in FIG. 1B, in another implementation, at first, extension is determined to be performed on the left side of the image 101, and a region 102 located on the left side of the image 101 is taken as a to-be-padded region. The region 102 is divided into three sub-regions, i.e., a sub-region 102a, a sub-region 102b, and a sub-region 102c. Then, the image 101 horizontally flipped to obtain an image 103; and the image 101, the region 102, and the image 103 are spliced such that the region 102 is located between the image 101 and the image 103. Next, the sub-region 102a is padded according to the image 101 and the image 103, followed by padding the sub-region 102b according to the image 101, the image 103, and the padded sub-region 102a. Finally, the sub-region 102c is padded according to the image 101, the image 103, the padded sub-region 102a, and the padded sub-region 102b. The image 103 is deleted to obtain an extended target image 105.

As shown in FIG. 1C, in yet another implementation, at first, extension is determined to be performed on the left side of the image 101, and a region 102d (this region 102d is smaller than the to-be-extended region) located on the left side of the image 101 is taken as a to-be-padded region. The image 101 is horizontally flipped to obtain an image 103; and the image 101, the region 102d, and the image 103 are spliced such that the region 102d is located between the image 101 and the image 103. Next, the region 102d is padded according to the image 101 and the image 103. The image 103 is deleted to obtain an image 106, and then a region 102e (the region 102d and the region 102e constitute the to-be-extended region) located on the left side of the image 106 is taken as the to-be-padded region. The region 102e is padded according to the image 106, so as to obtain an extended target image 107.

As shown in FIG. 1D, in yet another implementation, at first, extension is determined to be performed on the left side of the image 101, and a region 102f (this region 102f is smaller than the to-be-extended region) located on the left side of the image 101 is taken as a to-be-padded region. The region 102f is padded according to the image 101 to obtain an image 108. A region 102g (the region 102f and the region 102g constitute the to-be-extended region) located on the left side of the image 108 is then taken as the to-be-padded region. The image 108 is horizontally flipped to obtain an image 109; and the image 108, the region 102g, and the image 109 are spliced such that the region 102g is located between the image 108 and the image 109. Next, the region 102g is padded according to the image 108 and the image 109, and the image 109 is deleted to obtain a target image 110.

The present disclosure is described below in detail with reference to specific embodiments.

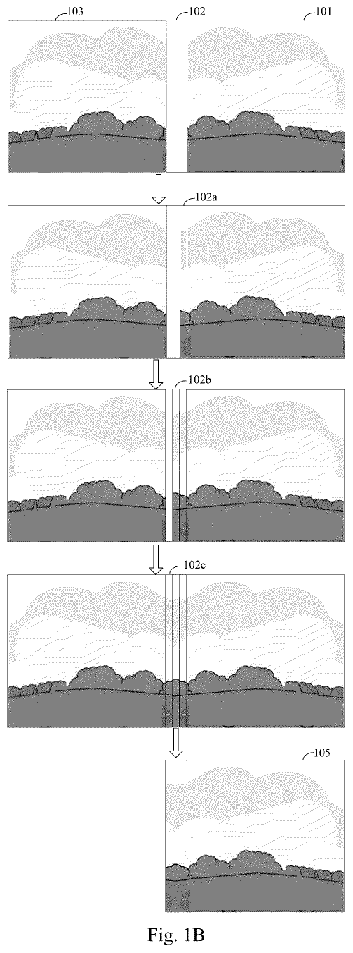

FIG. 2 is a flowchart illustrating a method for image extension according to an exemplary embodiment. An execution entity for this method may be implemented as any device, platform, server, or device cluster having computing and processing capabilities. The method includes the following steps.

As shown in FIG. 2, in S201, obtain a first image, and determine a first region on one side of the first image.

In this embodiment, at first, an original size of the first image and a target size of a target image can be obtained. Then, the size of a to-be-extended region is calculated according to the original size and the target size; and the to-be-extended region is determined to be located on one side of the first image, so as to obtain the to-be-extended first region.

In an implementation, the first image may be a to-be-extended original image, e.g., by reference to the embodiments of FIG. 1A, FIG. 1B, and FIG. 1C. The images 101 in FIG. 1A, FIG. 1B, and FIG. 1C may be taken as the first image. In another implementation, the first image may also be an image obtained by preprocessing the to-be-extended original image, e.g., by reference to the embodiment of FIG. 1D. In FIG. 1D, the image 108 that is obtained by performing extension the image 101 once may be taken as the first image as well.

With the embodiment shown in FIG. 1D being taken as an example, a fifth image may be obtained at first, the fifth image may be the to-be-extended original image, and the image 101 in FIG. 1D may be taken as the fifth image. Then, a third region on one side around the fifth image is determined, the third region may be a portion of a region to-be-extended, and the region 102f in FIG. 1D may be taken as the third region. Then, the fifth image and the third region are spliced and the third region is padded on the basis of a third known region in the fifth image in a preset padding mode, so as to obtain the first image, in which the third known region in the fifth image may be a partial or whole region of the fifth image, e.g., the partial or whole region of the image 101 in FIG. 1D may be taken as the third known region.

In this embodiment, the first region may be located on one side around the first image, e.g., the first region may be located on left side or right side of the first image, or located above or below the first image. The specific positional relationship between the first region and the first image is not defined in this embodiment. The first region may be at least a portion of a region to-be-extended at least the partial to-be-extended region, for example, reference is made to the embodiments of FIG. 1A and FIG. 1B. In these embodiments, the region 102 is the first region, i.e., the whole to-be-extended region. For another example, reference is made to the embodiments of FIG. 1C and FIG. 1D. The region 102d and the region 102g are the first region, i.e., the portion of the region to-be-extended.

In S202, flip the first image in a direction toward the first region to obtain a second image.

In this embodiment, the first image may be flipped in the direction toward the first region to obtain a flipped second image. For example, reference is made to the embodiments of FIG. 1A, FIG. 1B, FIG. 1C, and FIG. 1D. In these embodiments, the first region is located on the left side of the first image, so the first image needs to be horizontally flipped to obtain the second image. In FIG. 1A, FIG. 1B, and FIG. 1C, the image 103 obtained by flipping the image 101 may be taken as the second image. In FIG. 1D, the image 109 obtained by flipping the image 108 may be taken as the second image. It shall be noted that when the first region is located above or below the first image, the first image needs to be vertically flipped to obtain the second image.

In S203, splice the first image, the first region, and the second image to obtain a third image; and in S204, perform extension based on the third image to obtain a target image.

In this embodiment, the first region may be placed between the first image and the second image to obtain the third image, e.g., reference is made to the embodiments of FIG. 1A, FIG. 1B, FIG. 1C, and FIG. 1D. In FIG. 1A and FIG. 1B, the image obtained by splicing the image 101, the region 102 and the image 103 may be taken as the third image. In FIG. 1C, the image obtained by splicing the image 101, the region 102d and the image 103 may be taken as the third image. In FIG. 1D, the image obtained by splicing the image 108, the region 102g and the image 109 may be taken as the third image.

In this embodiment, an image extension operation may be performed on the basis of the spliced third image, so as to obtain the target image. Alternatively, the first region may be padded on the basis of a first known region in the third image in a preset padding mode, so as to obtain a fourth image. Then, the target image is obtained according to the fourth image. The first known region may include partial or whole regions corresponding to the first image and the second image. For example, reference is made to the embodiment of FIG. 1A, and in FIG. 1A, the region 102 may be padded according to the image 101 and the image 103 (i.e., the first known region) to obtain the fourth image. Then, the region in the fourth image, which corresponds to the image 103, is deleted to obtain the image 104 as the target image. For another example, reference is made to the embodiment of FIG. 1D, and in FIG. 1D, the region 102g may be padded according to the image 108 and the image 109 (i.e., the first known region) to obtain the fourth image. Then, the region in the fourth image, which corresponds to the image 109, is deleted to obtain the image 110 as the target image.

Further alternatively, the first region may be padded on the basis of the first known region in the third image to obtain the fourth image by: dividing the first region into a plurality of sub-regions at first, and orderly padding various sub-regions based on the first known region in the preset padding mode to obtain the fourth image; the first known region may further include a sub-region that has been padded. For example, reference is made to the embodiment of FIG. 1B, and in FIG. 1B, the region 102 may be divided into three sub-regions, i.e., the sub-region 102a, the sub-region 102b, and the sub-region 102c. Then, the sub-region 102a is padded on the basis of the image 101 and the image 103; followed by padding the sub-region 102b on the basis of the image 101, the image 103, and the padded sub-region 102a. Finally, the sub-region 102c is padded on the basis of the image 101, the image 103, the padded sub-region 102a, and the padded sub-region 102b, to obtain the fourth image. The region in the fourth image, which corresponds to the image 103, is deleted to obtain the image 105 as the target image. It shall be noted that the first region may be divided into a plurality of sub-regions in any reasonable mode, and the specific mode of dividing the first region is not defined in this embodiment.

The extension process in the above-described embodiment is divided into multiple stages and padding for the to-be-padded regions is also divided into multiple stages, making the region that is padded each time as the known region for next padding. As a result, each pixel in the to-be-padded regions is not too far away from its reference pixel during the padding process, which further improves the trueness and coherence of the extended region image.

Further alternatively, the target image may be obtained according to the fourth image by: deleting a region corresponding to the second image from the fourth image, so as to obtain a sixth image, and determining a second region located on one side around the sixth image. The sixth image and the second region are spliced, the second region is padded on the basis of a second known region in the sixth image in the preset padding mode, and the target image is obtained on the basis of the result of padding for the second region. For example, reference is made to the embodiment of FIG. 1C, and in FIG. 1C, the image 103 may be deleted from the fourth image obtained by padding the region 102d, so as to obtain the image 106 as the sixth image. Then, the region 102e located on the left side of the image 106 is taken as the second region, and the image 106 and the region 102e are spliced. After the region 102e is padded on the basis of the partial or whole region (i.e., the second known region) of the image 106, the image 107 is obtained as the target image.

According to a method for image extension provided in the present disclosure, a to-be-extended first image is flipped to obtain a second image, a to-be-padded first region located on one side around the first image is between the first image and the second image for splicing, so as to obtain a third image, and the third image is extended to obtain a target image. The to-be-padded first region is between the to-be-extended first image and the second image obtained by flipping the first image, the first region is padded by reference to the pixels of the first and second images, so during padding for the first region, each pixel in the first region is not too far away from its reference pixel, such that the image of the first region obtained by extension is more realistic, and the display effect is better and more coherent.

It shall be noted that this embodiment involves padding processes for empty regions. For example, in the embodiment of FIG. 1A, padding for the region 102 is involved. In the embodiment of FIG. 1B, padding for various sub-regions is involved. In the embodiment of FIG. 1C, padding for the region 102d and the region 102e is involved. And in the embodiment of FIG. 1D, padding for the region 102f and the region 102g is involved. Padding may be done in the preset padding mode, e.g., padding may be done directly with a pretrained generative model. Specifically, the image obtained by splicing the known region and the to-be-padded region is down-sampled, padded through a pretrained residual network, and then up-sampled to obtain the padded image. Alternatively, the to-be-padded region may also be padded with a known region on the basis of semantics. The process of padding on the basis of semantics will be described hereinbelow.

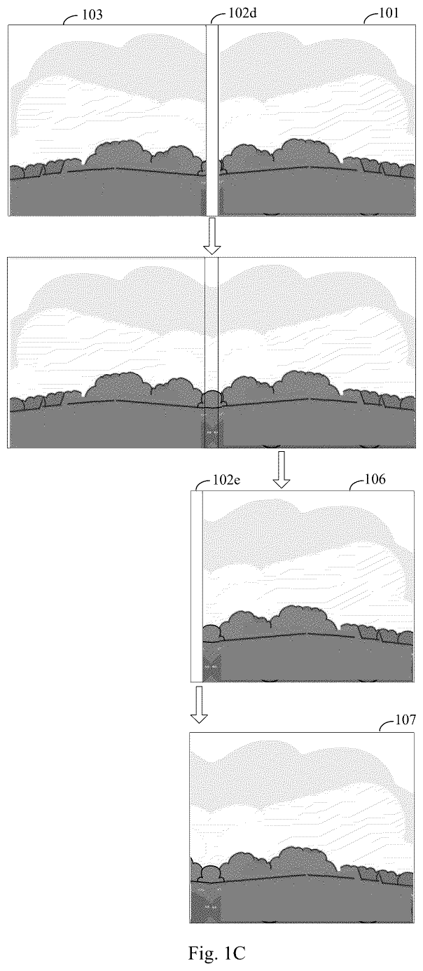

FIG. 3 is a flowchart illustrating another method for image extension according to an exemplary embodiment, and the process of padding in the preset padding mode is described in this embodiment and includes the following steps.

As shown in FIG. 3, in S301, determine first semantic information corresponding to the known region, and in S302, predict second semantic information corresponding to the to-be-padded region.

In this embodiment, first of all, the first semantic information corresponding to the known region may be obtained and the second semantic information corresponding to the to-be-padded region may be predicted, e.g., reference is made to the embodiments of FIG. 1A to FIG. 1D. In FIG. 1A, padding for the region 102 is involved, wherein the region 102 is the to-be-padded region and the regions corresponding to the image 101 and the image 103 are the known regions. In FIG. 1B, padding for various sub-regions is involved, wherein various sub-regions are the to-be-padded regions, and the region corresponding to the image 101, the region corresponding to the image 103, and the sub-region that has been padded are the known regions. In FIG. 1C, padding for the region 102d and the region 102e is involved, wherein the region 102d and the region 102e are the to-be-padded regions. When the region 102d is padded, the regions corresponding to the image 101 and the image 103 are the known regions. When the region 102e is padded, the region corresponding to the image 106 is the known region. In FIG. 1D, padding for the region 102f and the region 102g is involved, wherein the region 102f and the region 102g are the to-be-padded regions. When the region 102f is padded, the region corresponding to the image 101 is the known region. When the region 102g is padded, the regions corresponding to the image 108 and the image 109 are the known regions.

In this embodiment, the known region may be subjected to semantic segmentation using a preset semantic segmentation algorithm, so as to obtain the first semantic information corresponding to the known region. It should be noted that any method capable of semantic segmentation of a known image that is well-known in this art and might emerge in the future can be applied in this embodiment, and the specific mode of determining the first semantic information is not defined in this embodiment.

In this embodiment, the second semantic information corresponding to the to-be-padded region may be predicted using a pretrained model. For example, the image obtained by splicing the known region and the to-be-padded region is down-sampled, padded through a pretrained residual network, and up-sampled. Based on the image obtained from up-sampling, the second semantic information corresponding to the to-be-padded region is obtained.

In S303, pad the to-be-padded region according to the first semantic information, the second semantic information, and the known region.

In this embodiment, the known region may be semantically divided into at least one first divided region according to the first semantic information. The to-be-padded region is semantically divided into at least one second divided region according to the second semantic information. Then, for each of the second divided regions, this second divided region is padded on the basis of the first divided region having identical semantics to this second divided region, thereby accomplishing padding for the to-be-padded region. It can be understood that the first divided region may also be a divided region that is semantically similar to this second divided region.

During padding in this embodiment, the to-be-padded region is padded with the known region on the basis of semantics, so more targeted padding is achieved, and the image in the padded region is more reasonable, realistic, and more coherent.

It should be noted that although the operations of the method according to the embodiments of the present disclosure are described in a particular order in the above embodiments, this does not require or imply that these operations must be performed in that particular order, or that all of the operations shown must be performed in order to achieve the desired results. On the contrary, the order of execution for the steps depicted in the flowcharts can be changed. Additionally, or alternatively, some steps may be omitted, multiple steps may be combined into one step, and/or one step may be divided into multiple steps.

Also provided in the present disclosure is the embodiment of an apparatus for image extension that corresponds to the embodiment of the foregoing method for image extension.

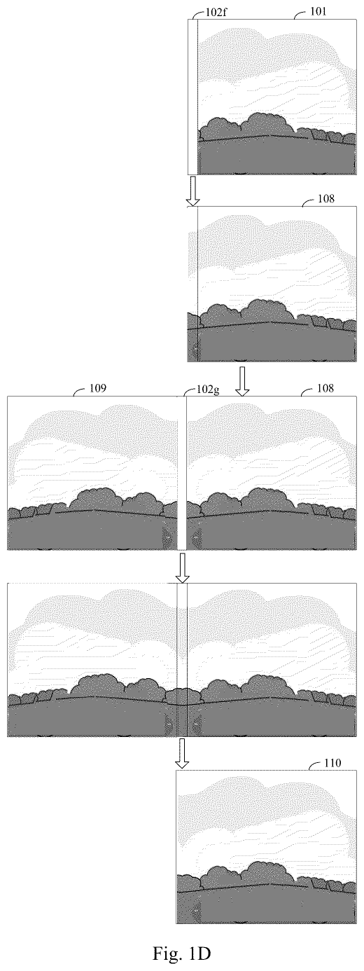

As shown in FIG. 4, FIG. 4 is a block diagram of an apparatus for image extension according to an exemplary embodiment of the present disclosure, and this apparatus may include: a determining module 401, a flipping module 402, a splicing module 403, and an extending module 404.

The determining module 401 is configured to obtain a first image, and determine a first region on one side of the first image.

The flipping module 402 is configured to flip the first image in a direction toward the first region to obtain a second image.

The splicing module 403 is configured to splice the first image, the first region, and the second image to obtain a third image, wherein the first region is between the first image and the second image.

The extending module 404 is configured to extend on the basis of the third image to obtain a target image.

In some implementations, the determining module 401 may include: a padding submodule and an obtaining submodule (not shown in the drawing).

A size obtaining submodule is configured to obtain an original size of the first image and a target size of the target image.

A determining submodule is configured to determine, based on the original size and the target size, the first region to be extended on one side of the first image.

In some other implementations, the extending module 404 may include: a padding submodule and an obtaining submodule (not shown in the drawing).

The padding submodule is configured to pad the first region on the basis of a first known region in the third image in a preset padding mode to obtain a fourth image, and the first known region includes regions corresponding to the first image and the second image.

The obtaining submodule is configured to obtain the target image according to the fourth image.

In some other implementations, the padding submodule is configured to: divide the first region into a plurality of sub-regions, and orderly pad the sub-regions based on the first known region in the preset padding mode to obtain the fourth image, wherein the first known region further includes a sub-region that has been padded.

In some other implementations, the determining module 401 obtains the first image by: obtaining a fifth image, and determining a third region on one side around the fifth image. The fifth image and the third region are spliced, and the third region is padded on the basis of a third known region in the fifth image in the preset padding mode to obtain the first image.

In some other implementations, the above preset padding mode includes a mode for padding a to-be-padded region using a known region on the basis of semantics.

In some other implementations, the to-be-padded region is padded with the known region on the basis of semantics by: determining first semantic information corresponding to the known region, predicting second semantic information corresponding to the to-be-padded region, and padding the to-be-padded region according to the first semantic information, the second semantic information, and the known region.

In some other implementations, the to-be-padded region is padded according to the first semantic information, the second semantic information, and the known region by: dividing, by semantics, the known region into at least one first divided region according to the first semantic information, dividing, by semantics, the to-be-padded region into at least one second divided region according to the second semantic information, and padding, for each of the second divided regions, the second divided region on the basis of the first divided region having identical semantics to the second divided region.

For the relevant parts of the apparatus embodiment, reference may be made to some of the description of the method embodiment. The apparatus embodiment described above is only exemplary, the modules illustrated therein as discrete components may or may not be physically separated, and the components displayed as modules may or may not be physical modules, i.e., may be located at one place, or distributed over a plurality of network modules. Some or all of the modules may be selected based on actual needs to achieve the purpose of the solutions of the embodiments of the present disclosure. Those ordinary skilled in the art can understand and implement them without any creative effort.

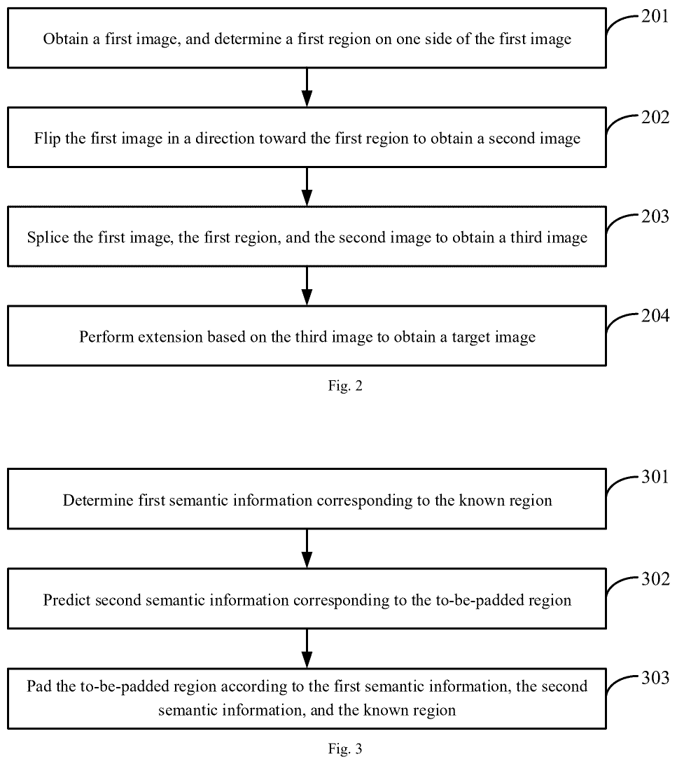

FIG. 5 is a schematic block diagram of an electronic device according to some embodiments of the present disclosure. As shown in FIG. 5, the electronic device 910 includes a processor 911 and a memory 912, and may serve to realize a client or a server. The memory 912 is used for non-transient storage of computer-executable instructions (e.g., one or more computer program modules). The processor 911 is used to run the computer-executable instructions, and the computer-executable instructions, when being run by the processor 911, can execute one or more steps in the method for image extension described above, thereby realizing the method for image extension described above. The memory 912 and processor 911 can be interconnected via a bus system and/or a connection mechanism in other form (not shown).

For example, the processor 911 may be a central processing unit (CPU), a graphics processing unit (GPU), or other form of processing unit with data processing capabilities and/or program execution capabilities. For example, the central processing unit (CPU) may have an X86 or ARM architecture, etc. The processor 911 may be a general-purpose processor or a special-purpose processor, and may control other components in the electronic device 910 to perform desired functions.

For example, the memory 912 may include any combination of one or more computer program products, and the computer program products may include various forms of computer-readable storage media, such as volatile memory and/or nonvolatile memory. Volatile memory may include, for example, random access memory (RAM) and/or cache. Nonvolatile memory may include, for example, read-only memory (ROM), hard disks, erasable programmable read-only memory (EPROM), portable compact disk read-only memory (CD-ROM), USB memory, flash memory, etc. One or more computer program modules may be stored on a computer-readable storage medium, and may be run by the processor 911 to realize various functions of the electronic device 910. In the computer-readable storage medium, it is also possible to store various applications and various data, as well as various data used and/or generated by applications, etc.

It should be noted that in the embodiments of the present disclosure, for the specific functions and technical effects of the electronic device 910, reference can be made to the aforesaid description regarding the method for image extension, and thus the description thereof is omitted here.

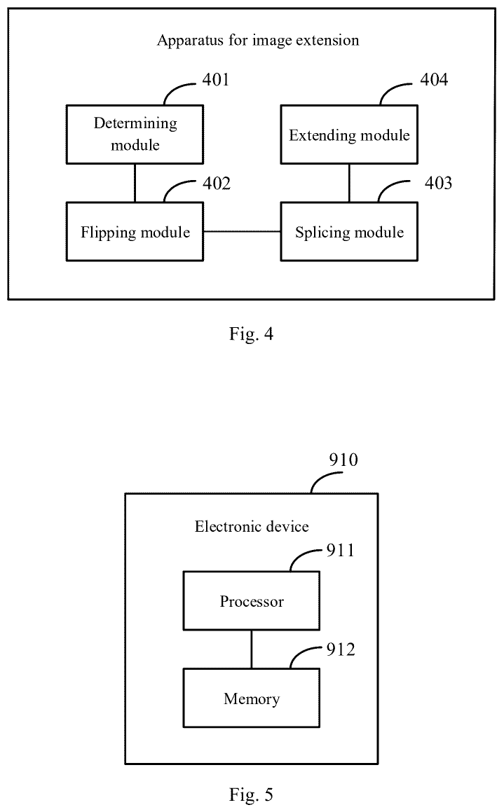

FIG. 6 is a schematic block diagram of another electronic device according to some embodiments of the present disclosure. This electronic device 920 is suitable, for example, for implementing the method for image extension according to the embodiment of the present disclosure. The electronic device 920 may be a terminal device or the like, and may be used to realize a client or a server. The electronic device 920 may include, but are not limited to, mobile terminals such as mobile phones, notebook computers, digital radio receivers, PDAs (personal digital assistants), PADs (tablets), PMP (portable multimedia players), vehicular terminals (such as vehicular navigation terminals), wearable electronic devices, etc., as well as fixed terminals such as digital TVs, desktop computers, smart home devices, etc. It should be noted that the electronic device 920 shown in FIG. 6 is merely an example and does not impose any limitations on the functionality and scope of use of the embodiments of the present disclosure.

As illustrated in FIG. 6, the electronic device 920 may include a processing apparatus 921 (e.g., a central processing unit, a graphics processing unit, etc.), which can perform various suitable actions and processing according to a program stored in a read-only memory (ROM) 922 or a program loaded from a storage apparatus 928 into a random-access memory (RAM) 923. The RAM 923 further stores various programs and data required for operations of the electronic device 920. The processing apparatus 921, the ROM 922, and the RAM 923 are interconnected by means of a bus 924. An input/output (I/O) interface 925 is also connected to the bus 924.

Usually, the following apparatus may be connected to the I/O interface 925: an input apparatus 926 including, for example, a touch screen, a touch pad, a keyboard, a mouse, a camera, a microphone, an accelerometer, a gyroscope, or the like; an output apparatus 927 including, for example, a liquid crystal display (LCD), a loudspeaker, a vibrator, or the like; a storage apparatus 928 including, for example, a magnetic tape, a hard disk, or the like; and a communication apparatus 929. The communication apparatus 929 may allow the electronic device 920 to be in wireless or wired communication with other devices to exchange data. While FIG. 6 illustrates the electronic device 920 having various apparatuses, it should be understood that not all of the illustrated apparatuses are necessarily implemented or included. More or fewer apparatuses may be implemented or included alternatively.

For example, according to the embodiment of the present disclosure, the above-described method for image extension may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 929 and installed, or may be installed from the storage apparatus 928, or may be installed from the ROM 922. When the computer program is executed by the processing apparatus 921, the above-mentioned functions defined in the method for image extension provided by the embodiments of the present disclosure can be realized.

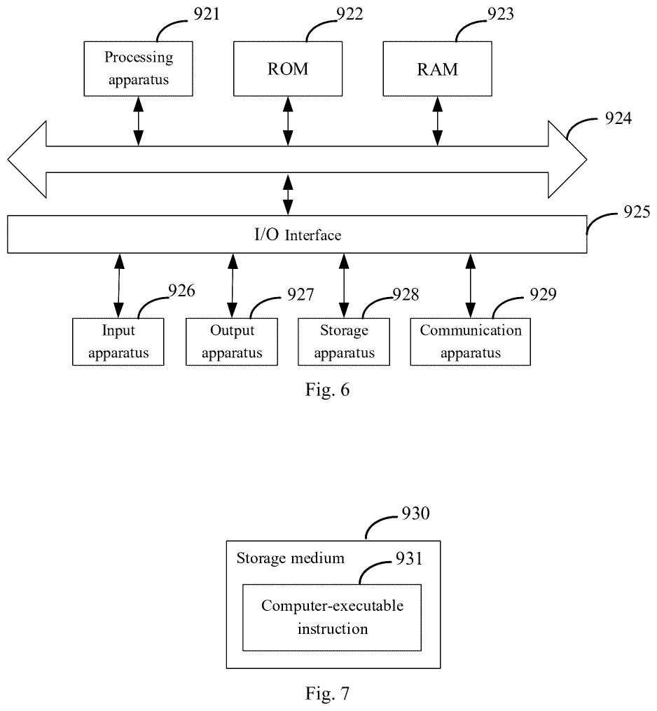

FIG. 7 is a schematic diagram of a storage medium according to some embodiments of the present disclosure. For example, as shown in FIG. 7, the storage medium 930 may be a non-transitory computer-readable storage medium for storing a non-transitory computer-executable instruction 931. When the non-transitory computer-executable instruction 931 is executed by a processor, the method for image extension described in the embodiment of the present disclosure can be realized, e.g., when the non-transitory computer-executable instruction 931 is executed by the processor, one or more steps in the method for image extension described hereinabove can be executed.

For example, the storage medium 930 may be applied in the above-described electronic device, e.g., the storage medium 930 may include the memory in the electronic device.

For example, storage media may include memory cards for smartphones, storage components for tablets, hard disks for personal computers, random access memory (RAM), read-only memory (ROM), erasable programmable read-only memory (EPROM), portable compact disk read-only memory (CD-ROM), flash memory, or any combination of the above storage media, and may also be other applicable storage media.

For example, for the description of the storage medium 930, reference can be made to the description of the memory in the embodiment of the electronic device, so the description thereof is omitted here. For the specific functions and technical effects of the storage medium 930, reference can be made to the aforesaid description regarding the method for image extension, so the description thereof is omitted here.

It should be noted that in the context of the present disclosure, a computer-readable medium may be a tangible medium that may contain or store programs for use by, or in combination with, an instruction execution system, apparatus, or device. The computer-readable medium may be a computer-readable signal medium, or a computer-readable storage medium, or any combination of the both. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The present disclosure is intended to cover any variants, uses, or adaptations of the present disclosure, and these variants, uses, or adaptations conform to the general principle of the present disclosure, and include common knowledge or customary technical means in this technical field that are not disclosed in the present disclosure. The embodiments of the present disclosure are considered as exemplary, and the true scope and spirit of the present disclosure are indicated by the claims.

It should be understood that the present disclosure is not limited to the precise structure already described above and shown in the drawings, and can be modified and altered in various ways without departing from its scope. The scope of the present disclosure is limited only by the attached claims.

1. A method for image extension, comprising:
obtaining a first image, and determining a first region on one side of the first image;
flipping the first image in a direction toward the first region to obtain a second image;
splicing the first image, the first region, and the second image to obtain a third image, wherein the first region is between the first image and the second image; and
performing extension based on the third image to obtain a target image.

2. The method according to claim 1, wherein the determining the first region on the one side of the first image, comprises:
obtaining an original size of the first image and a target size of the target image; and
determining, based on the original size and the target size, the first region to be extended on the one side of the first image.

3. The method according to claim 1, wherein the performing extension based on the third image to obtain the target image comprises:
padding the first region based on a first known region in the third image in a preset padding mode to obtain a fourth image, wherein the first known region comprises regions corresponding to the first image and the second image; and
obtaining the target image according to the fourth image.

4. The method according to claim 3, wherein the padding the first region based on the first known region in the third image in the preset padding mode to obtain the fourth image, comprises:
dividing the first region into a plurality of sub-regions; and
orderly padding the plurality of sub-regions based on the first known region in the preset padding mode to obtain the fourth image, wherein the first known region further comprises a sub-region that has been padded.

5. The method according to claim 1, wherein the obtaining the first image comprises:
obtaining a fifth image, and determining a third region on one side around the fifth image; and
splicing the fifth image and the third region, and padding the third region based on a third known region in the fifth image in a preset padding mode to obtain the first image.

6. The method according to claim 3, wherein the preset padding mode comprises:
a mode for padding a to-be-padded region using a known region based on semantics.

7. The method according to claim 6, wherein the mode for padding the to-be-padded region using the known region based on the semantics, comprises:
determining first semantic information corresponding to the known region;
predicting second semantic information corresponding to the to-be-padded region; and
padding the to-be-padded region according to the first semantic information, the second semantic information, and the known region.

8. The method according to claim 7, wherein the padding the to-be-padded region according to the first semantic information, the second semantic information, and the known region, comprises:
dividing, by the semantics, the known region into at least one first divided region according to the first semantic information;
dividing, by the semantics, the to-be-padded region into at least one second divided region according to the second semantic information; and
padding, for each of the second divided regions, the second divided region based on the first divided region having identical semantics to the second divided region.

9. (canceled)

10. A non-transitory computer readable storage medium, wherein is stored a computer program stored which, when the computer program is executed in a computer, causes the computer to execute a method for image extension, and the method comprises:
obtaining a first image, and determining a first region on one side of the first image;
flipping the first image in a direction toward the first region to obtain a second image;
splicing the first image, the first region, and the second image to obtain a third image, wherein the first region is between the first image and the second image; and
performing extension based on the third image to obtain a target image.

11. An electronic device, comprising a memory and a processor, wherein the memory has executable codes stored therein, and the processor, when executing the executable codes, implements a method for image extension, and the method comprises:
obtaining a first image, and determining a first region on one side of the first image;
flipping the first image in a direction toward the first region to obtain a second image;
splicing the first image, the first region, and the second image to obtain a third image, wherein the first region is between the first image and the second image; and
performing extension based on the third image to obtain a target image.

12. The electronic device according to claim 11, wherein the determining the first region on the one side of the first image, comprises:
obtaining an original size of the first image and a target size of the target image; and
determining, based on the original size and the target size, the first region to be extended on the one side of the first image.

13. The electronic device according to claim 11, wherein the performing extension based on the third image to obtain the target image comprises:
padding the first region based on a first known region in the third image in a preset padding mode to obtain a fourth image, wherein the first known region comprises regions corresponding to the first image and the second image; and
obtaining the target image according to the fourth image.

14. The electronic device according to claim 13, wherein the padding the first region based on the first known region in the third image in the preset padding mode to obtain the fourth image, comprises:
dividing the first region into a plurality of sub-regions; and
orderly padding the plurality of sub-regions based on the first known region in the preset padding mode to obtain the fourth image, wherein the first known region further comprises a sub-region that has been padded.

15. The electronic device according to claim 11, wherein the obtaining the first image comprises:
obtaining a fifth image, and determining a third region on one side around the fifth image; and
splicing the fifth image and the third region, and padding the third region based on a third known region in the fifth image in a preset padding mode to obtain the first image.

16. The electronic device according to claim 13, wherein the preset padding mode comprises:
a mode for padding a to-be-padded region using a known region based on semantics.

17. The electronic device according to claim 16, wherein the mode for padding the to-be-padded region using the known region based on the semantics, comprises:
determining first semantic information corresponding to the known region;
predicting second semantic information corresponding to the to-be-padded region; and
padding the to-be-padded region according to the first semantic information, the second semantic information, and the known region.

18. The electronic device according to claim 17, wherein the padding the to-be-padded region according to the first semantic information, the second semantic information, and the known region, comprises:
dividing, by the semantics, the known region into at least one first divided region according to the first semantic information;
dividing, by the semantics, the to-be-padded region into at least one second divided region according to the second semantic information; and
padding, for each of the second divided regions, the second divided region based on the first divided region having identical semantics to the second divided region.

19. The non-transitory computer readable storage medium according to claim 10, wherein the determining the first region on the one side of the first image, comprises:
obtaining an original size of the first image and a target size of the target image; and
determining, based on the original size and the target size, the first region to be extended on the one side of the first image.

20. The non-transitory computer readable storage medium according to claim 10, wherein the performing extension based on the third image to obtain the target image comprises:
padding the first region based on a first known region in the third image in a preset padding mode to obtain a fourth image, wherein the first known region comprises regions corresponding to the first image and the second image; and
obtaining the target image according to the fourth image.

21. The non-transitory computer readable storage medium according to claim 20, wherein the padding the first region based on the first known region in the third image in the preset padding mode to obtain the fourth image, comprises:
dividing the first region into a plurality of sub-regions; and
orderly padding the plurality of sub-regions based on the first known region in the preset padding mode to obtain the fourth image, wherein the first known region further comprises a sub-region that has been padded.
